(19) United States
(12) Patent Application Publication
(10) Pub. No.: US 2005/0139230 A1
(43) Pub. Date: Jun. 30, 2005

(54) Method for cleaning semiconductor wafers

(75) Inventors: Tsuyoshi Miyata, Kyoto (JP); Yuichi Miyoshi, Osaka (JP); Yoshiaki Namioka, Toyama (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/017,699

(22) Filed: Dec. 22, 2004

(30) Foreign Application Priority Data
Dec. 25, 2003 (JP) 2003-429457

(51) Int. Cl. B08B 3/00

(52) U.S. Cl. 134/2; 134/26; 134/27; 134/28

(57) ABSTRACT

A method for cleaning a semiconductor wafer according to the present invention includes the steps of: removing particles on a semiconductor wafer with an alkaline chemical solution to clean the wafer; neutralizing a surface charge of the semiconductor wafer with a weak acid cleaning solution; and removing residual metal impurities on the semiconductor wafer with an acid chemical solution to clean the wafer. The surface of the semiconductor wafer is neutralized and the HPM treatment is then performed with the semiconductor wafer having no charge. As a result, the surface of the semiconductor wafer can be made extremely clean without attaching metal impurities thereto.

### CROSS-REFERENCE TO RELATED APPLICATIONS

The present application claims priority under 35 USC 119(a) to Japanese Patent Application No. 2003-429457 filed on Dec. 25, 2003 the entire contents of which are hereby incorporated by reference.

### BACKGROUND OF THE INVENTION

(a) Field of the Invention

The present invention relates to a process of manufacturing semiconductor wafers, especially to a method for cleaning semiconductor wafers including the steps of cleaning for removing particles with an alkaline cleaning solution and cleaning for removing metal impurities with an acid cleaning solution.

(b) Description of Related Art

In a process of manufacturing semiconductor devices, fine particles, metal impurities and organic impurities are attached to semiconductor wafers. Since these particles and impurities attached to the semiconductor wafers cause device malfunction, cleanliness of the semiconductor wafers is managed to a rigid standard defined therefor so as not to leave particles and impurities attached to the wafers. In addition, with micronization and performance enhancement of semiconductor devices, the standards required for controlling particles, metal impurities and organic impurities become more rigid. In general, these particles and impurities can be removed by wet cleaning. The step of cleaning of semiconductor wafers, therefore, is very important in a process of manufacturing semiconductor devices.

Conventionally, to clean semiconductor wafers, a method has been employed for continuously treating semiconductor wafers with an alkaline ammonia hydroxide-hydrogen peroxide-water mixture (hereinafter referred to as APM), in which ammonia water and pure water are mixed together, and an acid hydrochloric acid-hydrogen peroxide-water mixture (hereinafter referred to as HPM), in which hydrochloric acid and pure water are mixed together, both mixtures containing hydrogen peroxide water as the base component (see, e.g., Japanese Unexamined Patent Publication No. 2000-138198).

This cleaning method is incorporated into a process of manufacturing semiconductor wafers to keep cleanliness high during each step, such as pre-gate clean requiring the highest cleanliness in the process. As a treatment system, the batch treatment is used in which a plurality of semiconductor wafers are simultaneously immersed in a cleaning chemical solution that is prepared in a treatment tank and retains heat therein.

In the cleaning, at first, particles on surfaces of semiconductor wafers are removed by APM. APM is an alkaline chemical solution having pH 10 or more, and has a feature that it will cause oxidation and reduction to proceed simultaneously. With the use of APM, a chemical oxide film of a few nanometer thick is formed on the surfaces of the semiconductor wafers by oxidation effect of hydrogen peroxide water, and at the same time the surfaces are slightly etched by reduction effect of ammonia water on the semiconductor wafers themselves or the chemical oxide film. The slight etching enables the particles to be removed from the semiconductor wafers and be dispersed into APM.

Then, the semiconductor wafers are washed in pure water to remove the residual APM on the surfaces thereof. The rinsing time with pure water is generally about 1-15 min.

Next, metal impurities attached to the surfaces of the semiconductor wafers are removed by HPM. HPM is an acid chemical solution having pH 1 or so, and serves to make the surfaces of the semiconductor wafers highly clean by extracting electrons from the metal impurities and dissolving the metal impurities to change into cations (positive ions).

### BRIEF SUMMARY OF THE INVENTION

However, the conventional method for cleaning semiconductor wafers has a problem of leaving metal impurities on the semiconductor wafers.

The present inventors studied the cause and found that a change in the surface potential of the semiconductor wafers due to cleaning relates to the residual impurities.

It can be considered that in a strongly alkaline chemical solution such as APM, the zeta potential of the semiconductor wafers is equal to that of particles and therefore the particles are removed without attaching to the semiconductor wafers again. In the cleaning process with APM, the formation of a chemical oxide film and the slight etching of the wafer surfaces occur simultaneously in the alkaline chemical solution containing a large amount of anions (negative ions). The anions are incorporated into the chemical oxide film grown in APM, and thus the chemical oxide film has negative charge. Hence, the surfaces of the semiconductor wafers after cleaning with APM become negatively charged.

The conventional cleaning method then proceeds to a rinse treatment with pure water in order to remove the residual APM on the semiconductor wafers. The pure water having the neutral pH can remove the residual APM but hardly neutralize the charge on the surfaces of the semiconductor wafers. Therefore, the cleaning with HPM is performed on the surfaces of the semiconductor wafers being negatively charged.

However, metal impurities sometimes remain in the cleaning tank of the cleaning apparatus. The metal impurities may be ionized and dissolve out into HPM within the cleaning tank. Moreover, since HCl contained in HPM has high permeability to metals, the metals constituting the cleaning apparatus body may also be ionized and dissolve out into HPM. The object of the cleaning with HPM is to remove the metal impurities. However, since in the conventional cleaning method the surfaces of the semiconductor wafers are negatively charged as mentioned above, there is the possibility that cations dissolving into HPM, such as metal ions, attach to the semiconductor wafers.

When a gate oxide film is formed with the metal impurities attached to the surfaces of the semiconductor wafers, Qbd characteristics (the amount of charge passing through the oxide film until dielectric breakdown occurs), which is one of the important characteristics of the oxide film, become worse, and as a result adequate characteristics of the oxide film cannot be obtained. While in this way the gate oxidation apparatus serves as a source of contamination to the semiconductor wafers, the semiconductor wafers also serve as a source of contamination to the apparatus. To prevent contamination caused by the metal impurities, the inner surface of the treatment tank of the cleaning apparatus is slightly etched with hydrofluoric acid or hydrofluoric and nitric acid to remove metal impurities therefrom. However, since the HPM cleaning is performed at high temperatures of 40-80° C. or so, metal impurities are diffused into the treatment tank and therefore it is difficult to remove the metal impurities inside of the treatment tank only by slightly etching the surface of the treatment tank. In addition, metal ions dissolving from the cleaning apparatus cannot be removed and metal impurities are also attached to the semiconductor wafers themselves. Hence, in the conventional cleaning method, contamination caused by metal impurities cannot be completely eliminated.

The object of the present invention is to provide a cleaning method capable of removing metal impurities on a semiconductor wafer.

To attain the above object, a method for cleaning a semiconductor wafer according to the present invention includes the steps of: (a) removing particles on the surface of the semiconductor wafer using an alkaline chemical solution to clean the semiconductor wafer; (b) after the step (a), neutralizing a surface charge of the semiconductor wafer; and (c) after the step (b), removing metal impurities on the surface of the semiconductor wafer using an acid chemical solution to clean the semiconductor wafer.

According to the above method, the step (c) of removing metal impurities is performed with the surface of the semiconductor wafer being neutralized, and thus it can be prevented that metal impurity ions having dissolved out into the acid chemical solution are attached to the semiconductor wafer. Therefore, by using the method for cleaning a semiconductor wafer according to the present invention, it is possible to make the surface of the semiconductor wafer highly clean and to prevent malfunction of a semiconductor device which is caused by particles or metal impurities on the semiconductor wafer.

In the step (b), the surface charge of the semiconductor wafer may be neutralized using a cleaning solution prepared at pH 3 to 6 both inclusive. Thereby, it is possible to neutralize the surface charge of the semiconductor wafer while preventing the metal impurities from dissolving in the cleaning solution during the step of neutralizing. Therefore, it is possible to prevent residual metal impurities within the cleaning tank from attaching to the semiconductor wafer.

The cleaning solution is preferably a solution or a mixture of two or more solutions selected from the group consisting of diluted hydrochloric acid, diluted nitric acid, diluted hydrofluoric acid and ozone water.

The acid concentration of the diluted hydrochloric acid, the diluted nitric acid and the diluted hydrofluoric acid in the cleaning solution is preferably 0.05% or less.

The ozone concentration of the ozone water is preferably within the range of 2 ppm to 30 ppm both inclusive.

The acid chemical solution used in the step (c) may be prepared to have pH 2 or less. As a result, metal impurities attached to the semiconductor wafer can be effectively eluted.

### BRIEF DESCRIPTION OF THE DRAWINGS

FIG. 1 is a process flow chart illustrating a method for cleaning semiconductor wafers according to an embodiment of the present invention;

FIG. 2(a) is a graph illustrating the relationship between surface potential of the semiconductor wafers and mass of metal contaminant in the cleaning solution in a conventional method, and FIG. 2(b) is a graph illustrating the relationship between surface potential of the semiconductor wafers and mass of metal contaminant in the cleaning solution in the cleaning method of the present invention;

FIG. 3 is a graph illustrating results of measurement for the amount of anions eluted from the semiconductor wafers after cleaning treatments using the method according to the present invention and the conventional method, respectively;

FIG. 4 is a graph illustrating results of measurement for the amount of cations eluted from the semiconductor wafers after the cleaning treatments using the method according to the present invention and the conventional method, respectively; and

FIG. 5 is a graph illustrating a comparison of initial failure ratios in Qbd characteristics between cleaning the semiconductor wafers by the method of the present invention and cleaning by the conventional method.

### DETAILED DESCRIPTION OF THE INVENTION

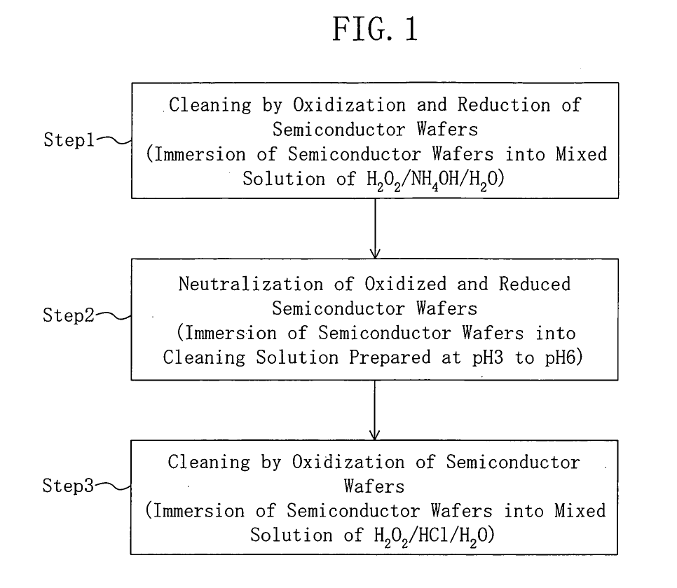

FIG. 1 is a process flow chart illustrating a method for cleaning semiconductor wafers according to an embodiment of the present invention. As shown in FIG. 1, the method for cleaning the semiconductor wafers of the embodiment includes the following first to third steps.

In the first step, the semiconductor wafers are immersed in a mixed solution of hydrogen peroxide water (H₂O₂), an ammonia water (NH₄OH) and pure water (H₂O) to clean the semiconductor wafers by their oxidation and reduction.

Next, in the second step, the semiconductor wafers after immersed in the mixed solution are immersed in a cleaning solution prepared at pH 3 to 6 both inclusive, such as an oxidized solution of any one of diluted hydrochloric acid, diluted nitric acid, diluted hydrofluoric acid and ozone water or a mixed oxidized solution of two or more kinds thereof, thereby neutralizing the surfaces of the semiconductor wafers by oxidization-reduction reaction.

Subsequently, in the third step, the immersed semiconductor wafers are taken out of the oxidized solution or the mixed oxidized solution, and then the semiconductor wafers are immersed in a mixed solution of hydrogen peroxide water, which is an oxidant, hydrochloric acid (HCl), which is strongly acid, and pure water to clean the semiconductor wafers by oxidization.

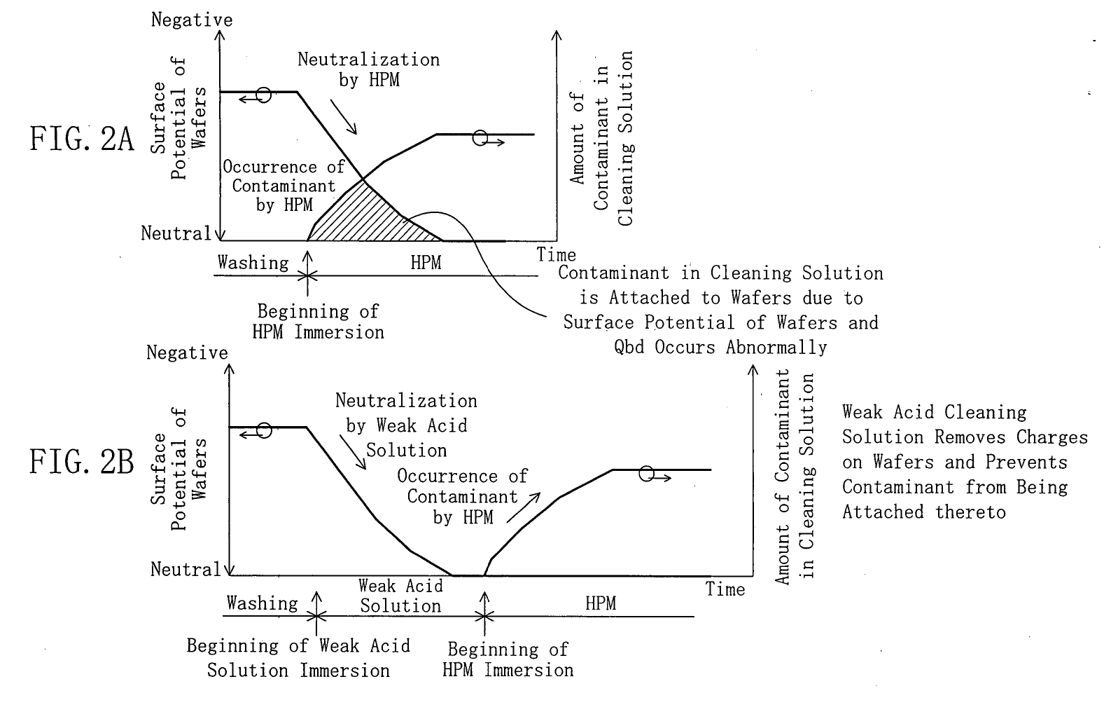

Referring to the drawings, the cleaning method of the aforementioned embodiment is described in more details. FIGS. 2(a) and 2(b) are graphs illustrating the relationship between surface potential of the semiconductor wafers and mass of metal contaminant in the cleaning solution in the conventional cleaning method and the cleaning method of the present invention, respectively. In the graphs, the ordinate axes denote the surface potential of the semiconductor wafers, and the abscissa axes denote time. Note that the higher the ordinate is, the larger negative potential becomes.

In the first step, to remove particles attached to the surfaces of the semiconductor wafers, the surfaces are cleaned with an alkaline ammonia hydroxide-hydrogen peroxide-water mixture (hereinafter referred to as APM) in which hydrogen peroxide water, ammonia water and pure water are mixed together. The immersion of the semiconductor wafers in APM enables simultaneous oxidization and reduction of the semiconductor wafers in the same tank, so that the surfaces of the semiconductor wafers are etched by a thickness of a few nanometers. This etching results in removal of particles and organic impurities on the surfaces of the semiconductor wafers. Since the zeta potential of the removed particles is the same as that of the surfaces of the semiconductor wafers, the particles are dispersed in the cleaning solution and removed without attaching to the semiconductor wafers. Moreover, the organic impurities are oxidized and dissolved in hydrogen peroxide water. The metal impurities are temporarily removed from the semiconductor wafers by the etching effect but are not captured in the cleaning solution of APM which is an alkaline cleaning solution. Therefore, the metal impurities are attached to the surfaces of the semiconductor wafers again. In APM, oxidization is more affected than reduction, and thus the surfaces of the wafers are reduced through a chemical oxide film having a thickness of 1 nm or so. The chemical oxide film contains anions because of its oxidization in the alkaline solution. Therefore, after the APM cleaning, the surfaces of the semiconductor wafers are completed with an anion-containing chemical oxide film having a thickness of 1 nm or so. Thereafter, before the second step, the semiconductor wafers may be washed.

In the second step, the semiconductor wafers are rinsed with a cleaning solution prepared at pH 3 to 6 both inclusive. This treatment can be conducted at room temperature but may be conducted at any temperatures other than room temperature. The higher the treatment temperature is, the shorter the time required for neutralizing the surfaces of the semiconductor wafers becomes. The rinsing is conducted for removal of residual APM on the semiconductor wafers and for neutralization of anions in the chemical oxide film. A suitable chemical solution for rinsing is, in consideration of influences on the third step, a diluted solution in which an acid chemical solution is diluted to have a concentration of 0.05% or less, such as diluted hydrochloric acid, diluted nitric acid, diluted hydrofluoric acid, or ozone water in which ozone gas is dissolved in pure water. In the case of using ozone water, the concentration of ozone is preferably within the range of 2 ppm to 30 ppm both inclusive. As illustrated in FIG. 2(b), at the end of the second step, the surface potential of the semiconductor wafers are neutralized. On the other hand, metal impurities, which are attached to the cleaning tank or exist in the semiconductor wafers, are little dissolved because the chemical solution is weakly acid and contains no H₂O₂.

Note that in the second step, an acid chemical solution of less than pH 3 also allows the neutralization of the chemical oxide film. However, when the concentration of cations is too high, the surfaces of the semiconductor wafers on the contrary charge cations. If the next step using an acid chemical solution is carried out with the surfaces of the semiconductor wafers being charged with cations, the zeta potential of the semiconductor wafers and that of the particles are inversed and therefore the particles are attached to the semiconductor wafers. For this reason, the cleaning solution having pH 3 to 6 both inclusive is most suitable for neutralizing anions in the chemical oxide film.

In the third step, the semiconductor wafers are cleaned with an acid hydrochloric acid-hydrogen peroxide-water mixture (hereinafter referred to as HPM) in which hydrogen peroxide water, hydrochloric acid, and pure water are mixed together. HPM is an acid cleaning solution of pH 1 or so and ionizes metal impurities on the surfaces of the semiconductor wafers to efficiently remove them. The removed metal contaminant is captured in HPM. As illustrated in FIG. 2(b), in the third step, the metal contaminant on the semiconductor wafers or the inner surface of the cleaning tank dissolves into HPM as the time passes. However, since the anions on the surfaces of the semiconductor wafers have been neutralized in the second step, the metal impurities captured in HPM are not attached to the semiconductor wafers. Therefore, according to the cleaning method of this embodiment, semiconductor wafers made highly clean can be obtained. Note that this method of this embodiment may be performed using either a batch treatment system or a single-wafer system.

On the other hand, in the conventional cleaning method, as illustrated in FIG. 2(a), the surfaces of the semiconductor wafers are negatively charged at the beginning of cleaning with HPM. Thus, prior to the completion of neutralization of the semiconductor wafers, metal impurities are dissolved out into HPM. Therefore, the dissolved metal impurities are attached to the surfaces of the semiconductor wafers. The cleaning method of the present invention solves this problem caused by the conventional cleaning method.

Next, the effects of the method for cleaning the semiconductor wafers in the above embodiment of the present invention are described in comparison with the conventional cleaning method.

For comparison between both cleaning methods, semiconductor wafers normally used prior to the formation of a gate oxide film were cleaned under the following conditions. The cleaning apparatus employed a single-tank system and continuously performed treatments in the first to the third steps and drying.

In the first step, the semiconductor wafers were treated by immersing them in APM (mixing ratio H₂O₂:NH₄OH:H₂O=1:1:8) at 80° C. for 10 min. Next, in the second step, the semiconductor wafers were treated by immersing them in dissolved ozone water of an ozone concentration of 3 ppm at room temperature for 5 min. In the third step, the semiconductor wafers were treated by immersing them in HPM (mixing ratio H₂O₂:HCl:H₂O=1:1:20) at 60° C. for 10 min.

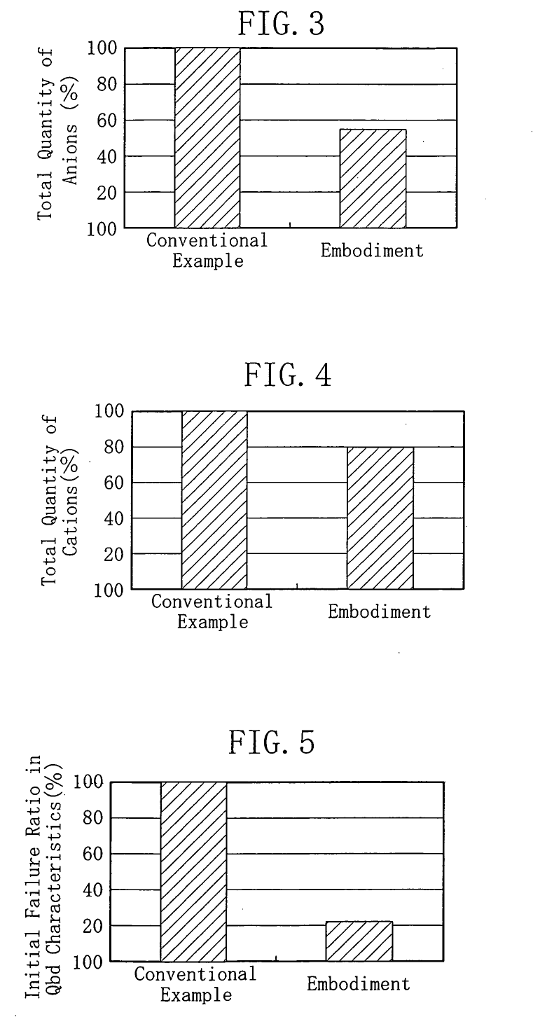

FIG. 3 is a graph illustrating results of measurement for the amount of anions eluted from the semiconductor wafers after the cleaning treatments using the method according to the present invention and the conventional method, respectively. FIG. 4 is a graph illustrating results of measurement for the amount of cations eluted from the semiconductor wafers after the cleaning treatments using the method according to the present invention and the conventional method, respectively. Note that the measurement is performed by ion chromatography and the results of the measurement are indicated with reference to the total quantity of ions in the conventional cleaning method (100%). FIGS. 3 and 4 show that the larger the total quantity of residual ions on the wafers is, the much contaminant is attached to the wafers.

FIG. 3 shows that in the cleaning method of the above embodiment, the total quantity of residual anions on the wafers is reduced to 54.9% of that in the conventional cleaning method. Moreover, FIG. 4 shows that in the cleaning method of the above embodiment, the total quantity of residual cations on the wafers is reduced to 80.1% of that in the conventional cleaning method. Therefore, according to the cleaning method of the above embodiment, the total quantity of residual anions and the total quantity of residual cations on the wafers can be reduced by introducing the neutralization step between the cleaning step with APM and the cleaning step with HPM. Here, the decrease of the total quantity of cations means the decrease of metal ions. Therefore, it is understood that in the cleaning method of the above embodiment, metal ions are prevented from being attached to the wafers during the cleaning step with HPM.

FIG. 5 is a graph illustrating a comparison of initial failure ratios in Qbd characteristics between cleaning the semiconductor wafers by the method according to the present invention and cleaning by the conventional method. Each of the results illustrated in FIG. 5 was obtained by forming thermally oxidized films on the cleaned semiconductor wafer, respectively, and measuring the initial failure ratio which is one of Qbd characteristics of the film. Note that FIG. 5 shows the treatment failure ratio in the case of using the cleaning method of the present invention with reference to the initial failure ratio in the conventional cleaning method (100%).

From the results shown in FIG. 5, it is understood that the initial failure ratio in the case of using the cleaning method of the above embodiment is reduced to 22.7% of that in the case of using the conventional cleaning method. These results also show that the cleaning method of the above embodiment has a high efficiency for preventing cations, such as metal ions, from being attached to the semiconductor wafers.

Note that in the second step of the above embodiment (neutralization step), a dissolved ozone water prepared at pH 3 to 6 both inclusive may be used as a cleaning solution as mentioned above. Alternatively, a cleaning solution of any one or a mixed cleaning solution of two or more kinds of diluted hydrochloric acid, diluted nitric acid, diluted hydrofluoric acid and ozone water, which are prepared at pH 3 to 6 both inclusive, exhibits the same effect as shown in FIGS. 3-5. The diluted hydrochloric acid, the diluted nitric acid and/or the diluted hydrofluoric acid contained in the cleaning solution used in this case have an acid concentration of 0.05% or less. The ozone water in the cleaning solution used in this case preferably has an ozone concentration of 2 ppm to 30 ppm both inclusive.

HPM used in the third step shown in FIG. 1 has normally pH1 or so, but HPM having pH 2 or less can remove the metal impurities or the like sufficiently.

The method for cleaning semiconductor wafers according to the present invention is applicable to cleaning of a semiconductor device using an alkaline cleaning solution and an acid cleaning solution.

1. A method for cleaning a semiconductor wafer, comprising the steps of:
(a) removing particles on the surface of the semiconductor wafer using an alkaline chemical solution to clean the semiconductor wafer;
(b) after the step (a), neutralizing a surface charge of the semiconductor wafer; and
(c) after the step (b), removing metal impurities on the surface of the semiconductor wafer using an acid chemical solution to clean the semiconductor wafer.

2. The method of claim 1, wherein in the step (b), the surface charge of the semiconductor wafer is neutralized using a cleaning solution prepared at pH 3 to 6 both inclusive.

3. The method of claim 2, wherein the cleaning solution is a solution or a mixture of two or more solutions selected from the group consisting of diluted hydrochloric acid, diluted nitric acid, diluted hydrofluoric acid and ozone water.

4. The method of claim 3, wherein the diluted hydrochloric acid, the diluted nitric acid and/or the diluted hydrofluoric acid contained in the cleaning solution have an acid concentration of 0.05% or less.

5. The method of claim 3, wherein the ozone concentration of the ozone water is within the range of 2 ppm to 30 ppm both inclusive.

6. The method of claim 1, wherein the acid chemical solution used in the step (c) is prepared at pH 2 or less.
